(19) United States
(12) Patent Application Publication
(10) Pub. No.: US 2023/0058330 A1
(43) Pub. Date: Feb. 23, 2023

(54) DISCOVERY OF SERVICE INSTANCE

(71) Applicant: Nokia Solutions and Networks Oy, Espoo (FI)

(72) Inventor: Thomas DEISS, Herne (DE)

(21) Appl. No.: 17/796,882

(22) PCT Filed: Feb. 21, 2020
(86) PCT No.: PCT/EP2020/054672

§ 371 Date: Aug. 2, 2022

(51) Int. Cl. H04L 41/5019; H04L 41/5009; H04L 41/40

(52) U.S. Cl. CPC H04L 41/5019; H04L 41/5009; H04L 41/40

(57) ABSTRACT

It is provided a method, comprising monitoring if a request to provide a service for a first network function is received; acquiring a stored service level requirement for the service if the request is received; checking whether an instance of a second network function providing the service fulfills the service level requirement; inhibiting providing an identifier of the instance of the second network function to the first network function in response to the request if the instance of the second network function does not fulfill the service level requirement.

### FIELD OF THE INVENTION

The present invention relates to network function discovery.

Abbreviations

3GPP 3rd Generation Partnership Project

4G/5G 4th/5th Generation

app application

AppD Application Descriptor

BTS Base Transceiver Station

CPU Central Processing Unit

DC Data Center

ETSI European Telecommunications Standard Institute

id identifier

KPI Key Performance Indicator

MEC Multi-access Edge Computing

MEP Multi-access Edge Platform

NFV Network Function Virtualization

NFVO Network Function Virtualization Orchestrator

NRF Network Repository Function

RNIS Radio Network Information Service

RTT Round-Trip Time

SLA Service Level Agreement

TS Technical Specification

UE User Equipment

VNF Virtual Network Function

### BACKGROUND OF THE INVENTION

Network functionality is provided increasingly as virtual network functions (VNFs) instead of physical appliances. Often, VNFs are seen as providing a set of abstract services, with each VNF providing one or more services and requiring one or more services. A VNF might also require the use of platform services such as the radio network information service (RNIS) or some location services of MEC. To discover other VNFs providing a requested service a service registry may be used which replies to a request for a specific service with information how to connect to a VNF providing this service (e.g. IP address or another identification of the VNF). Examples of this approach are MEC and the service discovery as described in [MEC011]. The 5G core network with the network repository function (NRF) [23.501, 23.502] is another example. The description of the invention will be based on MEC terminology, without reducing its generality.

### REFERENCES

[MEC010-2]: ETSI GS MEC 010-2 V2.1.1 (2019-11), Multi-access Edge Computing (MEC); MEC Management; Part 2: Application lifecycle, rules and requirements management

[MEC011]: ETSI GS MEC 011 V1.1.1 (2017-07), Mobile Edge Platform Application Enablement

[MEC016]: ETSI GS MEC 016 V2.1.1 (2019-04), Multi-access Edge Computing (MEC); UE application interface

[23.501]: 3GPP TS 23.501, 2018, System Architecture for the 5G System

[23.502]: 3GPP TS 23.502, 2018, Procedures for the 5G System

[D3.1] 5G-Crosshaul, D3.1, Sect. 8.1, 5g-crosshaul.eu/deliverables

### SUMMARY OF THE INVENTION

It is an object of the present invention to improve the prior art.

According to a first aspect of the invention, there is provided an apparatus, comprising means for obtaining configured to obtain a service level requirement for a service required by a first network function; means for deploying configured to deploy at least one instance of a second network function providing the service such that the service level requirement for the service is fulfilled.

According to a second aspect of the invention, there is provided an apparatus, comprising means for monitoring configured to monitor if a request to provide a service for a first network function is received; means for acquiring configured to acquire a stored service level requirement for the service if the request is received; means for checking configured to check whether an instance of a second network function providing the service fulfills the service level requirement; means for inhibiting configured to inhibit providing an identifier of the instance of the second network function to the first network function in response to the request if the instance of the second network function does not fulfill the service level requirement.

According to a third aspect of the invention, there is provided a method, comprising obtaining a service level requirement for a service required by a first network function; deploying at least one instance of a second network function providing the service such that the service level requirement for the service is fulfilled.

According to a fourth aspect of the invention, there is provided a method, comprising monitoring if a request to provide a service for a first network function is received; acquiring a stored service level requirement for the service if the request is received; checking whether an instance of a second network function providing the service fulfills the service level requirement; inhibiting providing an identifier of the instance of the second network function to the first network function in response to the request if the instance of the second network function does not fulfill the service level requirement.

Each of the methods of the third and fourth aspects may be a method of discovery of a service instance.

According to a fifth aspect of the invention, there is provided a computer program product comprising a set of instructions which, when executed on an apparatus, is configured to cause the apparatus to carry out the method according to any of the third and fourth aspects. The computer program product may be embodied as a computer-readable medium or directly loadable into a computer.

According to some embodiments of the invention, at least one of the following advantages may be achieved:
SLA requirements for a service may be taken into account for orchestration and service discovery;
Allows to discover an optimum VNF instance to provide a service under the condition of the SLA requirement;
Overall SLA requirement or KPI may be improved;
No need to modify discovery requests by network functions;
Orchestration and discovery across multiple datacenters taking into account the SLA requirements without a need to define the relationship among VNF instances beforehand.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein:

FIG. 1 shows a deployment according to an example embodiment of the invention;

FIG. 2 shows an apparatus according to an example embodiment of the invention;

FIG. 3 shows a method according to an example embodiment of the invention;

FIG. 4 shows an apparatus according to an example embodiment of the invention;

FIG. 5 shows a method according to an example embodiment of the invention; and

FIG. 6 shows an apparatus according to an example embodiment of the invention.

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given by way of example only, and that it is by no way intended to be understood as limiting the invention to the disclosed details.

Moreover, it is to be understood that the apparatus is configured to perform the corresponding method, although in some cases only the apparatus or only the method are described.

Several instances of a VNF may be created by a network function virtualization orchestrator (NFVO), each providing the same set of services. Therefore, the service registry has a choice to select a specific VNF instance in response to a service discovery request. E.g. 3GPP in [23.501] has defined potential criteria to support this selection for different types of network functions. Examples of such criteria are network slice ids, UE identies, tracking area ids.

If a platform service, such as RNIS, is requested, there may be a similar problem of selecting a particular instance if several platform instances, e.g. the multi-access edge platform (MEP), exist. These platform instances may even access the same BTSs, wherein one instance might be close to the BTS, and other instances might be farther away. Compute resources at the mobile edge with low latency are considered to be more costly than resources in a central datacentre (typically higher latency). Therefore, there is trade-off between cost of providing a service and latency to access the service. Here, an orchestrator has to choose an appropriate instance of the platform being able to serve a specific VNF instance.

When large scale networks are deployed using VNFs, there may be several instances of the same VNF deployed in different data centers. In such a scenario, in a first step, the orchestrator has to deploy the VNF services requiring a service in an appropriate datacentre. This decision may be based e.g. on SLA requirements such as maximum latency on the virtual links between VNFs or required bandwidth of these VNFs.

For a VNF requiring a platform service, virtual links to which the SLA requirements could be attached do not exist. In MEC AppDs there is just a list of the services required.

In a second step, after deploying the VNFs, the service registry has to select among several instances those that provide a requested service satisfying the SLA requirements.

Selection rules based on area ids such as tracking area ids as in [23.501] are applicable in some specific circumstances, but are not sufficient in general to describe different metrics for optimality. E.g. the trade-off between the latency to access a platform service and the cost of accessing the service cannot be described properly, as there may be several instances in the same area that could provide a specific service.

When deploying networks using appliances, the problem of selecting VNF instances does not occur. When deploying networks using VNFs, where all instances are in the same datacentre, it is sufficient to consider whether VNF instances are in the same rack or in different racks. Simple affinity or affinity rules are sufficient.

Deploying VNF instances to different datacenters based on SLA requirements on virtual links or among them is a topic of active research in several research projects. For distributed deployments, rules similar to those defined by 3GPP in [23.501] are not flexible enough. Work on optimal placement of VNF instances, see e.g. https://projects.tmforum.org/wiki/display/PCT/Maximizing+Profitability+with+NFV+Orchestration+Catalyst+Project+Charter, is a prerequisite. Still, the proper VNF instances have to establish connection among themselves.

The application descriptor in MEC (see [MEC010-2]) contains an attribute appLatency. The definition of this attribute does not specify to which other application, connection point, or service access point this latency should apply. Neither does this single attribute allow to distinguish latency towards specific services.

[MEC016] allows applications in devices to request a list of MEC applications provided by a MEC instantiation. The reply may contain for each application the supported latency, as well as needed bandwidth and memory, CPU of the MEC applications. The actual values in the reply can be filled from the information in the service registry after the MEC applications are instantiated and their connectivity is established using service discovery.

According to some example embodiments of the invention, the list of services required by a MEC App comprises SLA requirements, such as the maximum latency allowed for a service. A main use case are platform services such as RNIS, for which no virtual links are defined to which the SLA requirements are attached. However, the list of required services comprising SLA requirements is not limited to platform services. SLA requirements may be included in the list for other requested services as well, allowing to specify SLA requirements per required service. The SLA requirements of the required services are uploaded from NVFO to the service registry.

An orchestrator (e.g. NVFO) may deploy VNF instances such that these SLA requirements can be satisfied.

To support that appropriate instances of VNFs are connected to each other or to appropriate platform instances, in some example embodiments, the NFVO provides its knowledge of the network topology including the VNF and platform instances to the service registry. The SLA requirements, such as link latencies, available bandwidths, number of hops, etc., are provided as well, as a part of the topology relevant metrics. In some example embodiments, a VNF may provide its SLA requirements of a required service directly to both the NFVO and the service registry. These two options to inform the service registry on the SLA requirements may be combined. E.g. for different services of one VNF or for different VNFs, the service registry may get the SLA requirements on different paths.

In a service discovery step, i.e. when trying to discover a VNF instance or platform instance providing a specific service, the service registry will return only such VNF instance or platform instances satisfying the SLA requirements. If a VNF instance or platform instance does not fulfil the SLA requirement, the service registry is inhibited to return an id of this VNF instance or platform instance.

In some example embodiments of the invention, the service registry may order the discovered instances according to the same criteria the orchestrator has used for its deployment decision, e.g. according to ascending cost. In this case, either the values of the criteria are predefined in the NFVO and the service registry, or one of these entities informs the other of these entities on the values of the criteria. In addition, NFVO may inform the service registry on the used criteria. This allows the VNF instance requesting the discovery of an instance providing the service to select an optimal instance providing the service while still satisfying the SLA requirements.

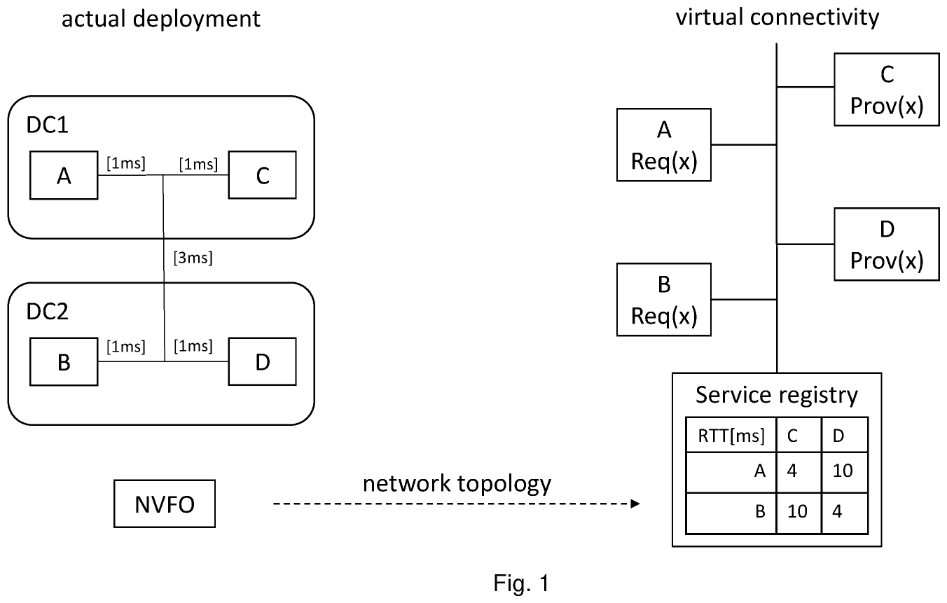

FIG. 1 shows a deployment according to an example embodiment of the invention. The actual deployment is shown on the left side. The virtual connectivity of the VNF instances A, B, C, and D and the relevant entry in the service registry is shown on the right side. In this example the NVFO deployed the VNF instances A, B, C, and D to two datacenters DC1 and DC2. Link latencies for each link are known to the NFVO. They are 1 ms from each of the VNF instances to a hub in the respective DC, and 3 ms between the hubs of the two datacenters. The NFVO provides the link latencies (or RTT, which is in this case twice the link latency) to the service registry, which stores them in the table shown on the bottom right side of FIG. 1. NFVO may provide further information on the network topology to the service registry.

The VNF instances A and B each require an abstract service x, which is provided by each of VNF instances C and D. The service registry may determine the RTT among these VNF instances based on the stored table, potentially using further network topology information, too.

If one of VNF instances A and B actually requires to provide service x (and potentially other services), the list of required services comprises an SLA requirement, stating that service x has to be provided with an SLA requirement, e.g. a RTT of 5 ms. If VNF instance A requests the service x with this SLA requirement, the service registry replies to the service discovery request with VNF instance C but not with VNF instance D because the RTT A-D is too long. If VNF instance B issues the same service discovery request, the service registry replies with VNF instance D, but not with VNF instance C because the RTT B-C is too long.

Similarly, if a VNF instance requests discovery of a platform instance for a platform service, the SLA requirements it can return an optimal platform instance because the service registry is aware of the topology. Typically, in this case, the platform instance and the VNF instance are in the same datacentre.

NFVO Implementation:
a) Assuming that an NFVO is already capable of deploying VNF or MEC app instances such that SLA requirements on virtual links are satisfied, the NFVO needs to be extended with reading the SLA requirements associated with the list of required services of a MEC app. The information and datamodels in such NFVO may be extended.
b) Conveying topology from the NFVO to the service registry: There are two general implementation options to exchange the information between NFVO and service registry:
   1) The NFVO may push this information to the service registry, e.g. as a 2-dimensional matrix of the metric values between pairs of VNF instances (see FIG. 1).
   2) The NFVO may provide a topology and inventory interface, see e.g. [D3.1], which the service registry could use to get the required information.

Service Registry Implementation:

Based on the network service descriptors and on the SLA requirements associated to the required services in MEC App descriptors, the service registry may be extended with a data model similar to the one of the NFVO. Also, the service registry may be extended with similar topology information as the NFVO. Based on this information similar logic as in the NFVO for making deployment decisions may be implemented.

Due to similarity of the datamodels and decision logic in NFVO and service registry in the implementations described above, there is a further implementation option: One may create an interface from the service registry to the NFVO, which allows to request the VNF instance from the NFVO based on the SLA requirement provided in a discovery request for a service. This option ensures consistency of the decisions of the NFVO and service registry and avoids that the service registry has to learn topology information.

In such an implementation, a relevant operation called by the service registry on the NFVO may be:

DiscoverInstance(a, s, V)→[v1, . . . , vn]

where

a is a VNF instance of MEC app instance;

s is a service required by instance a;

V is a VNF or MEC app, whose instances provide service s. V could also be a platform such as the MEP if a platform service is required.

[v1, . . . , vn] is a list of instances of V, satisfying the SLA requirements of service s when provided to instance a.

Some example embodiments of the invention cover the following additional aspects:
The invention is applicable in the context of network slicing (with different topologies and metrics per network slice instance) and for service-based architectures/micro-services.
The NFVO may update topology changes and corresponding changes of the metric values to the service registry for future service discovery requests.
The service registry may notify a VNF instance requiring a service, that due to topology change there are other more optimal VNF instances providing the service. In this case, the requesting VNF instance can terminate its connection to the previous instance providing the service and establish a connection to the better one.
although MEC has been used as example, some example embodiments of the invention hold to any network functionality deployed as VNFs and using some kind of service registry to identify/discover other VNF instances.
Although VNF and NFVO are terms defined by ETSI NFV ISG, some example embodiments the invention apply to any kind of virtualization

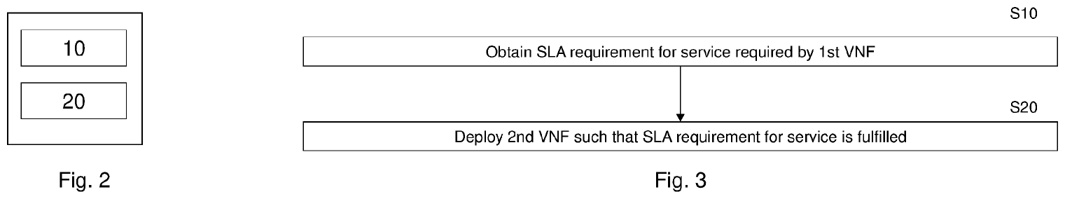

FIG. 2 shows an apparatus according to an embodiment of the invention. The apparatus may be an orchestrator, such as a NVFO, or an element thereof. FIG. 3 shows a method according to an embodiment of the invention. The apparatus according to FIG. 2 may perform the method of FIG. 3 but is not limited to this method. The method of FIG. 3 may be performed by the apparatus of FIG. 2 but is not limited to being performed by this apparatus.

The apparatus comprises means for obtaining 10 and means for deploying 20. The means for obtaining 10 and means for deploying 20 may be obtaining means and deploying means 20, respectively. The means for obtaining and means for deploying means 20 may be an obtainer and deployer, respectively. The means for obtaining 10 and means for deploying 20 may be an obtaining processor and deploying processor, respectively.

The means for obtaining 10 obtains a service level requirement for a service required by a first network function (S10). The first network function may be a virtual network function.

The means for deploying 20 deploys at least one instance of a second network function providing the service such that the service level requirement for the service is fulfilled (S20). The second network function may be a virtual network function.

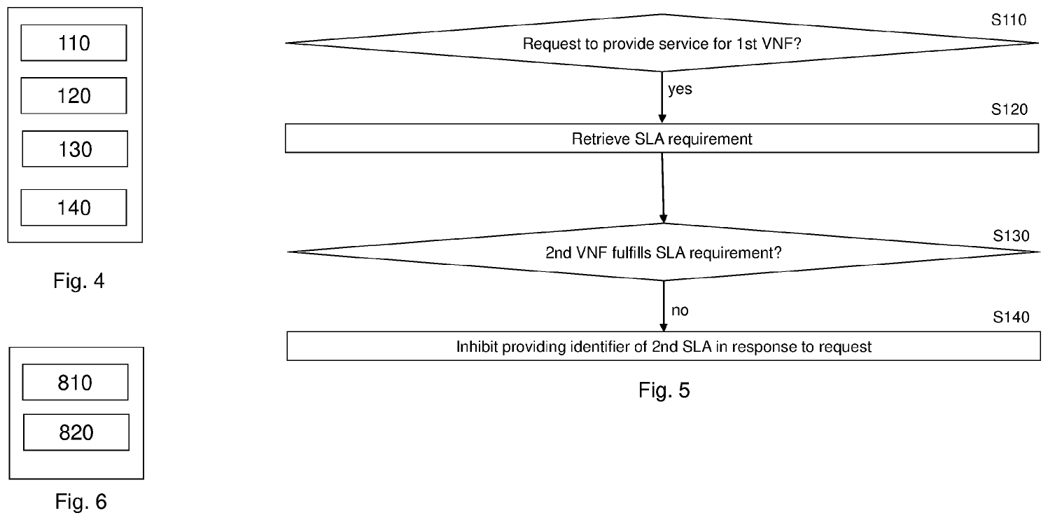

FIG. 4 shows an apparatus according to an embodiment of the invention. The apparatus may be a registry, such as a service registry, or an element thereof. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises means for monitoring 110, means for acquiring 120, means for checking 130, and means for inhibiting 140. The means for monitoring 110, means for acquiring 120, means for checking 130, and means for inhibiting 140 may be monitoring means, acquiring means, checking means and inhibiting means 140, respectively. The means for monitoring 110, means for acquiring 120, means for checking 130, and means for inhibiting means 140 may be a monitor, acquirer, checker, and inhibitor, respectively. The means for monitoring 110, means for acquiring 120, means for checking 130, and means for inhibiting 140 may be a monitoring processor, acquiring processor, checking processor, and inhibiting processor, respectively.

The means for monitoring 110 monitors if a request to provide a service for a first network function is received (S110). The first network function may be a virtual network function.

If the request is received (S110=yes), the means for acquiring 120 acquires a stored service level requirement for the service (S120). For example, the means for acquiring 120 may retrieve the stored service level requirement from a service registry.

The means for checking 130 checks whether an instance of a second network function providing the service fulfills the service level requirement (S130). The second network function may be a virtual network function.

If the instance of the second network function does not fulfill the service level requirement (S130=no), the means for inhibiting 140 inhibits providing an identifier of the instance of the second network function to the first network function in response to the request (S140).

FIG. 6 shows an apparatus according to an embodiment of the invention. The apparatus comprises at least one processor 810, at least one memory 820 including computer program code, and the at least one processor 810, with the at least one memory 820 and the computer program code, being arranged to cause the apparatus to at least perform at least one of the methods according to FIGS. 3 and 5.

Some example embodiments of the invention are described for 5G networks with MEC. However, the invention is neither restricted to 5G networks nor to MEC. The invention may be employed for other communication networks such as 4G networks, non-3GPP networks, or even wired networks, too. Instead of the service discovery of MEC, another service discovery such as that in the 5G core network by NRF may be used.

One piece of information may be transmitted in one or plural messages from one entity to another entity. Each of these messages may comprise further (different) pieces of information.

Names of network elements, network functions, protocols, and methods are based on current standards. In other versions or other technologies, the names of these network elements and/or network functions and/or protocols and/or methods may be different, as long as they provide a corresponding functionality.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. Each of the entities described in the present description may be embodied in the cloud.

According to the above description, it should thus be apparent that example embodiments of the present invention provide, for example, a orchestrator such as a NVFO, or a component thereof, an apparatus embodying the same, a method for controlling and/or operating the same, and computer program(s) controlling and/or operating the same as well as mediums carrying such computer program(s) and forming computer program product(s). According to the above description, it should thus be apparent that example embodiments of the present invention provide, for example, a terminal such as a service registry, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non-limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1-26. (canceled)

27. Apparatus, comprising
means for obtaining configured to obtain a service level requirement for a service required by a first network function;
means for deploying configured to deploy at least one instance of a second network function providing the service such that the service level requirement for the service is fulfilled.

28. The apparatus according to claim 27, wherein the respective service level requirement comprises at least one of a latency requirement for the service, a bandwidth requirement for the service, and a maximum number of hops for the service.

29. The apparatus according to claim 27, further comprising
means for providing configured to provide the respective service level requirement along with an indication of the first network function and an indication of the service to a service registry.

30. The apparatus according to claim 29, wherein
the means for providing is configured to push the service level requirement along with the indication of the first network function and the indication of the service to the service registry.

31. The apparatus according to claim 29, wherein
the means for providing is configured to provide an interface exposing the service level requirement along with the indication of the first network function and the indication of the service to allow a service registry to retrieve the service level requirement along with the indication of the first network function and the service from the interface.

32. The apparatus according to claim 27, wherein
the means for deploying is configured to deploy plural instances of the second network function according to a sorting criterion such that the service level requirement for the service is fulfilled; and the apparatus further comprises
means for informing configured to inform the service registry on the sorting criterion.

33. Apparatus, comprising
means for monitoring configured to monitor if a request to provide a service for a first network function is received;
means for acquiring configured to acquire a stored service level requirement for the service if the request is received;
means for checking configured to check whether an instance of a second network function providing the service fulfills the service level requirement;
means for inhibiting configured to inhibit providing an identifier of the instance of the second network function to the first network function in response to the request if the instance of the second network function does not fulfill the service level requirement.

34. The apparatus according to claim 33, further comprising
means for providing configured to provide the identifier of the instance of the second network function to the first network function in response to the request if the instance of the second network function fulfills the service level requirement.

35. The apparatus according to claim 34, wherein
the means for checking is configured to check that each of plural instances of the second network function fulfill the service level requirement; and the apparatus further comprises
means for receiving configured to receive an indication of a sorting criterion;
means for sorting configured to sort a list of the instances of the second network function fulfilling the service level requirement according to the sorting criterion; wherein
the means for providing is configured to provide the sorted list of instances of the second network function in response to the request.

36. The apparatus according to claim 33, wherein the service level requirement comprises at least one of a latency acceptable for the service, a bandwidth requirement acceptable for the service, and an acceptable number of hops between the first network function and the second network function.

37. The apparatus according to claim 33, further comprising
means for supervising configured to supervise if the service level requirement for providing the service for the first network function is received from an orchestrator;
means for storing configured to store the service level requirement for providing the service for the first network function if the service level requirement is received from the orchestrator.

38. The apparatus according to claim 33, further comprising
means for retrieving configured to retrieve the service level requirement for providing the service for the first network function from an orchestrator;
means for storing configured to store the service level requirement for providing the service for the first network function if the service level requirement is retrieved from the orchestrator.

39. Method, comprising
monitoring if a request to provide a service for a first network function is received;
acquiring a stored service level requirement for the service if the request is received;
checking whether an instance of a second network function providing the service fulfills the service level requirement;
inhibiting providing an identifier of the instance of the second network function to the first network function in response to the request if the instance of the second network function does not fulfill the service level requirement.

40. The method according to claim 39, further comprising
providing the identifier of the instance of the second network function to the first network function in response to the request if the instance of the second network function fulfills the service level requirement.

41. The method according to claim 40, further comprising
checking that each of plural instances of the second network function fulfill the service level requirement;
receiving an indication of a sorting criterion;
sorting a list of the instances of the second network function fulfilling the service level requirement according to the sorting criterion; wherein
the sorted list of instances of the second network function is provided in response to the request.

42. The method according to claim 39, wherein the service level requirement comprises at least one of a latency acceptable for the service, a bandwidth requirement acceptable for the service, and an acceptable number of hops between the first network function and the second network function.

43. The method according to claim 39, further comprising
supervising if the service level requirement for providing the service for the first network function is received from an orchestrator;
storing the service level requirement for providing the service for the first network function if the service level requirement is received from the orchestrator.

44. The method according to claim 39, further comprising
retrieving the service level requirement for providing the service for the first network function from an orchestrator;
storing the service level requirement for providing the service for the first network function if the service level requirement is retrieved from the orchestrator.
